(19) United States
(12) Patent Application Publication
(10) Pub. No.: US 2013/0120657 A1
(43) Pub. Date: May 16, 2013

(54) SYSTEM AND METHOD FOR RENDERING ANTI-ALIASED TEXT TO A VIDEO SCREEN

(71) Applicants: Justin T. Dick, Salt Lake City, UT (US); Andrew J. Schneider, Irvine, CA (US); Huy Q. Tran, Westminster, CA (US)

(72) Inventors: Justin T. Dick, Salt Lake City, UT (US); Andrew J. Schneider, Irvine, CA (US); Huy Q. Tran, Westminster, CA (US)

(73) Assignee: The DIRECTV Group, Inc., El Segundo, CA (US)

(21) Appl. No.: 13/294,139

(22) Filed: Nov. 10, 2011

(51) Int. Cl. G09G 5/00; H04N 5/00

(52) U.S. Cl. 348/607; 348/E05.001

(57) ABSTRACT

Text is rendered to a television screen using only the alpha channel. This is accomplished by delaying blending with underlying video until the end of the process to thereby preserve the alpha channel information. Glyphs are used to graphically represent character data in the text to be rendered. Glyphs can be stored in a character texture. In addition, the glyphs can be contained in rectangles having identifiable locations in the character texture. The rectangles can have sizes dependent upon the glyph the rectangle contains.

### BACKGROUND

1. Field

Embodiments relate to efficient text rendering on a video display. More particularly, embodithents relate to rendering smooth anti-aliased text on a video display over both existing graphics and live or recorded video.

2. Background

Conventional methods for rendering text use the set top box (STB) CPU to blend pixels corresponding to character glyphs with a background color. That is, the color components of a character glyph are used during the rendering process to create a blended pixel with a fixed color value. In conventional systems, this blending is performed at the beginning of the process, and uses the alpha component to determine the color and transparency of a new pixel prior to compositing with underlying video. As a result, the alpha component is lost during blending. Thus, in conventional systems, blending with underlying data is performed using premultiplied data, which lacks an alpha component.

While conventional processing provides anti-aliasing against existing graphics, due to the loss of the alpha component in the prior blending, it does not provide anti-aliasing against underlying video. As a result, the text over such underlying video in a conventional set top box has a blocky appearance. Further, because the STB CPU is responsible for the blending operation, text in general can require significant CPU resources to display.

### SUMMARY

To overcome the aforementioned problems, in an embodiment text is rendered to a video screen, such as a television screen, using only the alpha channel. This is accomplished by delaying blending with underlying video until the end of the process to thereby preserve the alpha channel information. Glyphs are used to graphically represent character data in the text to be rendered. Glyphs can be stored in a character texture. In addition, the glyphs can be contained in rectangles having identifiable locations in the character texture. The rectangles can have sizes dependent upon the glyph the rectangle contains.

In an embodiment, a system to render text on a television screen includes a memory, a frame buffer to store data to be displayed on the television screen, a processor to obtain to the text to be rendered to the television screen; and a blitter to blit glyphs corresponding to the text to a destination rectangle in the frame buffer, wherein the glyphs are blitted using only the alpha channel.

In another embodiment, a method for rendering render text on a television screen includes storing data to be displayed on a television screen in a frame buffer, obtaining the text to be rendered to the television screen, blitting glyphs corresponding to the text to a destination rectangle in the frame buffer, wherein the glyphs are blitted using only the alpha channel.

Additional features and embodiments of the present invention will be evident in view of the following detailed description of the invention.

### BRIEF DESCRIPTION OF THE DRAWINGS

FIG. 1 is a schematic diagram of an exemplary system for providing television services in a television broadcast system, such as a television satellite service provider, according to an embodiment.

FIG. 2 is a simplified schematic diagram of an exemplary set top box according to an embodiment.

FIG. 3 is a portion of an exemplary glyph cache (or character texture) that represents a character alphabet according to an embodiment.

FIG. 4 is a flow chart for a method for rendering text to a television screen according to an embodiment.

FIG. 5 illustrates a portion of an exemplary lookup table for determining the location of glyphs in a character texture according to an embodiment.

### DETAILED DESCRIPTION

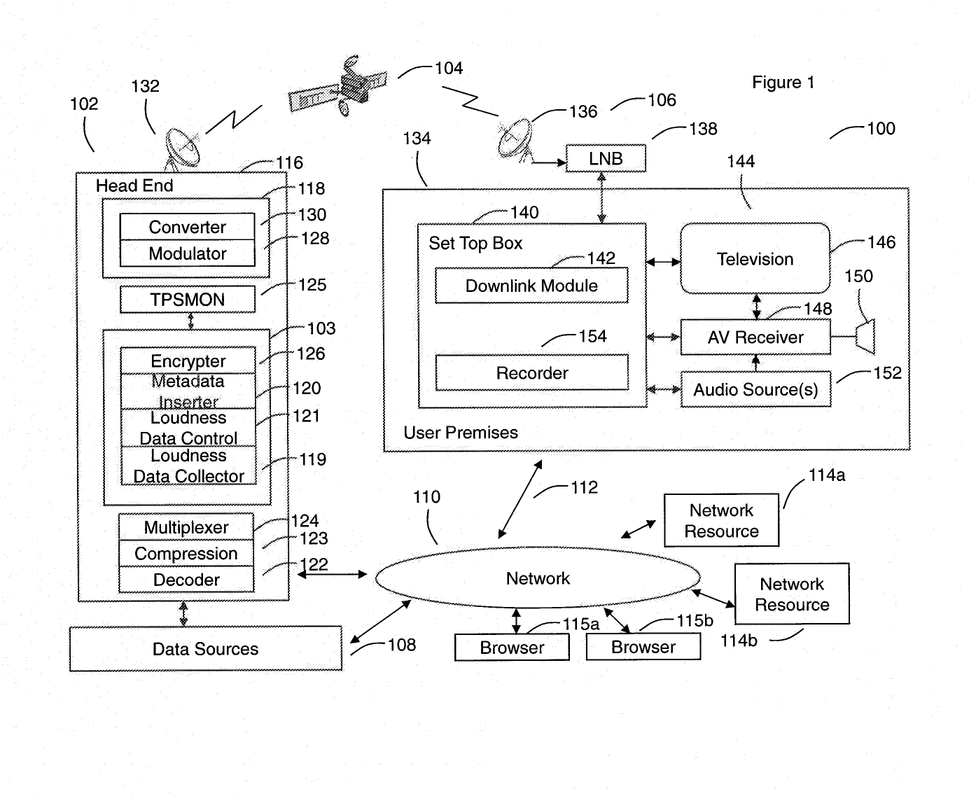

FIG. 1 is a schematic diagram of an exemplary system 100 for providing television services in a television broadcast system, such as a television satellite service provider, according to an embodiment. As shown in FIG. 1, exemplary system 100 is an example direct-to-home (DTH) transmission and reception system 100. The example DTH system 100 of FIG. 1 generally includes a transmission station 102, a satellite/relay 104, and a plurality of receiver stations, one of which is shown at reference numeral 106, between which wireless communications are exchanged at any suitable frequency (e.g., Ku-band and Ka-band frequencies). As described in detail below with respect to each portion of the system 100, information from one or more of a plurality of data sources 108 is transmitted from transmission station 102 to satellite/relay 104. Satellite/relay 104 may be at least one geosynchronous or geo-stationary satellite. In turn, satellite/relay 104 rebroadcasts the information received from transmission station 102 over broad geographical area(s) including receiver station 106. Exemplary receiver station 106 is also communicatively coupled to transmission station 102 via a network 110. Network 110 can be, for example, the Internet, a local area network (LAN), a wide area network (WAN), a conventional public switched telephone network (PSTN), and/or any other suitable network system. A connection 112 (e.g., a terrestrial link via a telephone line and cable) to network 110 may also be used for supplemental communications (e.g., software updates, subscription information, programming data, information associated with interactive programming, etc.) with transmission station 102 and/or may facilitate other general data transfers between receiver station 106 one or more network resources 114a and 114b, such as, for example, file servers, web servers, and/or databases (e.g., a library of on-demand programming).

Data sources 108 receive and/or generate video, audio, and/or audiovisual programming including, for example, television programming, movies, sporting events, news, music, pay-per-view programs, advertisement(s), game(s), etc. In the illustrated example, data sources 108 receive programming from, for example, television broadcasting networks, cable networks, advertisers, and/or other content distributors. Further, example data sources 108 may include a source of program guide data that is used to display an interactive program guide (e.g., a grid guide that informs users of particular programs available on particular channels at particular times and information associated therewith) to an audience. Users can manipulate the program guide (e.g., via a remote control) to, for example, select a highlighted program for viewing and/or to activate an interactive feature (e.g., a program information screen, a recording process, a future showing list, etc.) associated with an entry of the program guide. Further, example data sources 108 include a source of on-demand programming to facilitate an on-demand service.

An example head-end 116 includes a decoder 122 and compression system 123, a transport processing system (TPS) 103 and an uplink module 118. In an embodiment, decoder 122 decodes the information by for example, converting the information into data streams. In an embodiment, compression system 123 compresses the bit streams into a format for transmission, for example, MPEG-2 or MPEG-4. In some cases, AC-3 audio is not decoded, but passed directly through without first decoding. In such cases, only the video portion of the source data is decoded.

In an embodiment, multiplexer 124 multiplexes the data streams generated by compression system 123 into a transport stream so that, for example, different channels are multiplexed into one transport. Further, in some cases a header is attached to each data packet within the packetized data stream to facilitate identification of the contents of the data packet. In other cases, the data may be received already transport packetized.

TPS 103 receives the multiplexed data from multiplexer 124 and prepares the same for submission to uplink module 118. TPS 103 includes a loudness data collector 119 to collect and store audio loudness data in audio provided by data sources 108, and provide the data to a TPS monitoring system in response to requests for the data. TPS 103 also includes a loudness data control module 121 to perform loudness control (e.g., audio automatic gain control (AGC)) on audio data received from data source 108. Generally, example metadata inserter 120 associates the content with certain information such as, for example, identifying information related to media content and/or instructions and/or parameters specifically dedicated to an operation of one or more audio loudness operations. For example, in an embodiment, metadata inserter 120 replaces scale factor data in the MPEG-1, layer II audio data header and dialnorm in the AC-3 audio data header in accordance with adjustments made by loudness data control module 121.

In the illustrated example, the data packet(s) are encrypted by an encrypter 126 using any suitable technique capable of protecting the data packet(s) from unauthorized entities.

Uplink module 118 prepares the data for transmission to satellite/relay 104. In an embodiment, uplink module 118 includes a modulator 128 and a converter 130. During operation, encrypted data packet(s) are conveyed to modulator 128, which modulates a carrier wave with the encoded information. The modulated carrier wave is conveyed to converter 130, which, in the illustrated example, is an uplink frequency converter that converts the modulated, encoded bit stream to a frequency band suitable for reception by satellite/relay 104. The modulated, encoded bit stream is then routed from uplink frequency converter 130 to an uplink antenna 132 where it is conveyed to satellite/relay 104.

Satellite/relay 104 receives the modulated, encoded bit stream from the transmission station 102 and broadcasts it downward toward an area on earth including receiver station 106. Example receiver station 106 is located at a subscriber premises 134 having a reception antenna 136 installed thereon that is coupled to a low-noise-block downconverter (LNB) 138. LNB 138 amplifies and, in some embodiments, downconverts the received bitstream. In the illustrated example of FIG. 1, LNB 138 is coupled to a set-top box 140. While the example of FIG. 1 includes a set-top box, the example methods, apparatus, systems, and/or articles of manufacture described herein can be implemented on and/or in conjunction with other devices such as, for example, a personal computer having a receiver card installed therein to enable the personal computer to receive the media signals described herein, and/or any other suitable device. Additionally, the set-top box functionality can be built into an A/V receiver or a television 146.

Example set-top box 140 receives the signals originating at head-end 116 and includes a downlink module 142 to process the bitstream included in the received signals. Example downlink module 142 demodulates, decrypts, demultiplexes, decodes, and/or otherwise processes the bitstream such that the content (e.g., audiovisual content) represented by the bitstream can be presented on a display device of, for example, a media presentation system 144. Example media presentation system 144 includes a television 146, an AV receiver 148 coupled to a sound system 150, and one or more audio sources 152. As shown in FIG. 1, set-top box 140 may route signals directly to television 146 and/or via AV receiver 148. In an embodiment, AV receiver 148 is capable of controlling sound system 150, which can be used in conjunction with, or in lieu of, the audio components of television 146. In an embodiment, set-top box 140 is responsive to user inputs to, for example, to tune a particular channel of the received data stream, thereby displaying the particular channel on television 146 and/or playing an audio stream of the particular channel (e.g., a channel dedicated to a particular genre of music) using the sound system 150 and/or the audio components of television 146. In an embodiment, audio source(s) 152 include additional or alternative sources of audio information such as, for example, an MP3 player (e.g., an Apple® iPod), a Blueray® Blueray player, a Digital Versatile Disc (DVD) player, a compact disc (CD) player, a personal computer, etc.

Further, in an embodiment, example set-top box 140 includes a recorder 154. In an embodiment, recorder 154 is capable of recording information on a storage device such as, for example, analog media (e.g., video tape), computer readable digital media (e.g., a hard disk drive, a digital versatile disc (DVD), a compact disc (CD), flash memory, etc.), and/or any other suitable storage device.

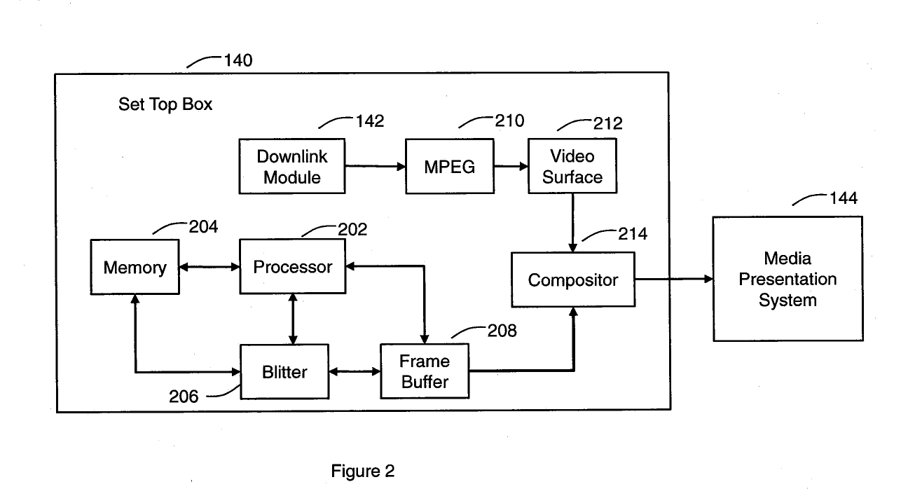

FIG. 2 is a simplified schematic diagram of an exemplary set top box (STB) 140 according to an embodiment. Such a set top box can be, for example, in the DIRECTV HR2x family of set top boxes. As shown in FIG. 2, STB 140 includes a downlink module 142 described above. In an embodiment, downlink module 142 is coupled to an MPEG decoder 210 that decodes the received video stream and stores it in a video surface 212 (memory).

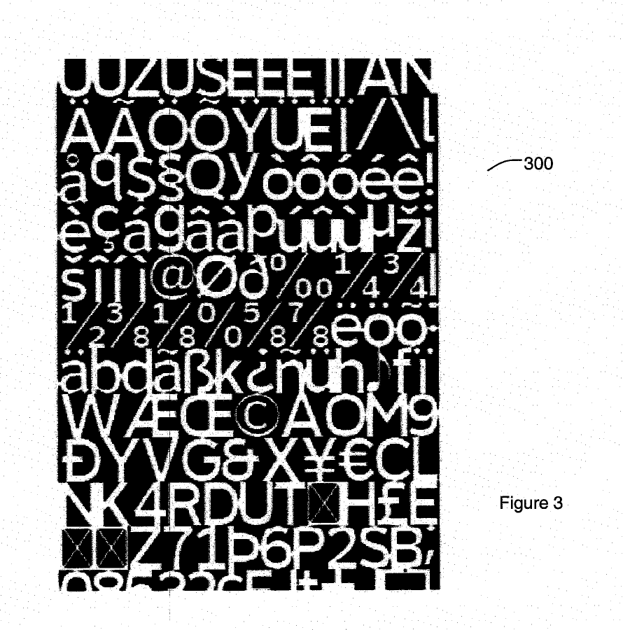

A processor 202 controls operation of STB 140. Processor 202 can be any processor that can be configured to perform the operations described herein for processor 202. Processor 202 has accessible to it a memory 204. In an embodiment, memory 204 is used to store at least one character texture. Each character texture has a plurality of glyphs, each glyph corresponding to a character that can be rendered. In an embodiment, each glyph is contained within a rectangle that has an identifiable location in the character texture. In an embodiment, the size of each rectangle containing a glyph in the character texture is dependent upon the glyph it contains. In an embodiment, each character texture corresponds to a particular character font that can be rendered on television 146. Thus, in an embodiment, each unique font is represented by a unique character texture. The character textures are also referred to as glyph caches. An exemplary character texture is described with respect to FIG. 3.

Memory 204 can also be used as storage space for recorder 154 (described above). Further, memory 204 can be used to store programs to be run by processor 202 as well as used by processor 202 for other functions necessary for the operation of STB 140 as well as the functions described herein. In alternate embodiments, one or more additional memories may be implemented in STB 140 to perform one or more of the foregoing memory functions.
A blitter 206 performs block image transfer (BLIT or Wit) operations. In embodiments, blitter 206 performs BLIT operations on one or more character textures stored in memory 204 to transfer one or more glyphs from the character texture to a frame buffer 208. In this manner, blitter 206 is able to render text over a graphics image stored frame buffer 208. In an embodiment, blitter 206 is a co-processor that provides hardware accelerated block data transfers. Blitter 206 renders characters using reduced memory resources and does not require direct access to the frame buffer. A suitable blitter for use in embodiments is the blitter found in the DIRECTV HR2x family of STBs.

Frame buffer 208 stores an image or partial image to be displayed on media presentation system 144. In an embodiment, frame buffer 208 is a part of memory 204. In an embodiment, frame buffer 208 is a 1920×1080×4 bytes buffer that represents every pixel on a high definition video screen with 4 bytes of color for each pixel. In an embodiment, the four colors are red, blue, green, and alpha. In an embodiment, the value in the alpha component (or channel), can range from 0 (fully transparent) to 255 (fully opaque).

A compositor 214 receives data stored in frame buffer 208 and video surface 212. In an embodiment, compositor 214 blends the data it receives from frame buffer 208 with the data it receives from video surface 212 and forwards the blended video stream to media presentation 144 for presentation.

In an embodiment, text is rendered using only the alpha channel of the pixel and blending is delayed to the end of the process, when the text is rendered over the live video. Further, in an embodiment, text is rendered using the graphics hardware of the STB rather than the CPU. As a result, CPU cycles are saved because the CPU no longer has the burden of rendering graphics over video.

Because text rendering is performed at the end of the process, the alpha channel is still present. In an embodiment, each pixel stored in frame buffer 208 has an alpha component at the time compositor 214 performs blending because blending is not earlier performed. Thus, when compositor 214 blends the data in frame buffer 208 with the video in video surface 212, it blends the text rendered in the alpha channel over the live or recorded video. This results in nearly perfect anti-aliased text over video background.

In an embodiment, each character texture, or glyph cache, is an alphabet of characters. Each glyph represents a character in the alphabet. FIG. 3 illustrates a portion of an exemplary character texture 300 (or glyph cache) that represents a character alphabet according to an embodiment. In operation, as a string is rendered, each character of the text is matched up with its corresponding glyph in the glyph cache. The matching glyphs are composited into a glyph string. The glyph string is blitted to the appropriate destination rectangle in frame buffer 208, wherein the appropriate destination rectangle corresponds to the location where the text is desired to appear on the television screen. The compositor then blends the contents of frame buffer 208 with the underlying MPEG video stream stored in video surface 212. In an embodiment, the compositor blending occurs each v-synch in the STB.

In an embodiment, user interface, close captioning text is stored in frame buffer 208. As a result, in an embodiment, frame buffer 208 stores glyph information in the correct location for a particular user interface in the alpha channel of corresponding pixels as well as any menus or graphics in the correct location. The menus and/or graphics can be pre-existing in frame buffer 208. As such, the entire user interface is laid out and stored in frame buffer 208. To enable viewing of underlying video, for each pixel that is not part of the user interface, frame buffer 208 stores the pixel color is (0,0,0,0), which corresponds to a completely transparent black pixel.

Although frame buffer 208 provides storage capacity for all colors, as described above, in an embodiment, for text, only the alpha channel is used from the source image, such as the glyph cache, to frame buffer 208. In an embodiment, a global color corresponding to the alpha channel is applied to a character texture when it is transferred to the frame buffer 208. In an embodiment, Witter 206 performs the transfer by moving a source rectangle in the character texture corresponding to the proper glyph to a destination rectangle in frame buffer 208, the destination rectangle corresponding to the position on a television screen where the character is to appear, and applying the global color.

In an embodiment, glyphs in a particular character texture can be represented by different numbers of pixels. For example, in an embodiment, a period can be represented by fewer pixels than, for example, a capital A. FIG. 3 is an exemplary texture containing multiple glyphs that can be used in an embodiment. As mentioned, the texture illustrated in FIG. 3 comprises a plurality of glyphs for a particular font. In an embodiment, each glyph in a character texture is contained within an rectangle having an identifiable location in the character texture. In such an embodiment, a glyph can be selected by choosing the coordinates of the rectangle for the glyph in the character texture. Such selection can be by a lookup table that contains the coordinates and size of each glyph in the texture. In such an embodiment, when a character is desired, the character is looked up in the table for the coordinates and size of the glyph in the texture corresponding to the character. The coordinates and size of the glyph in the texture provide the location for where to obtains pixels corresponding to the character.

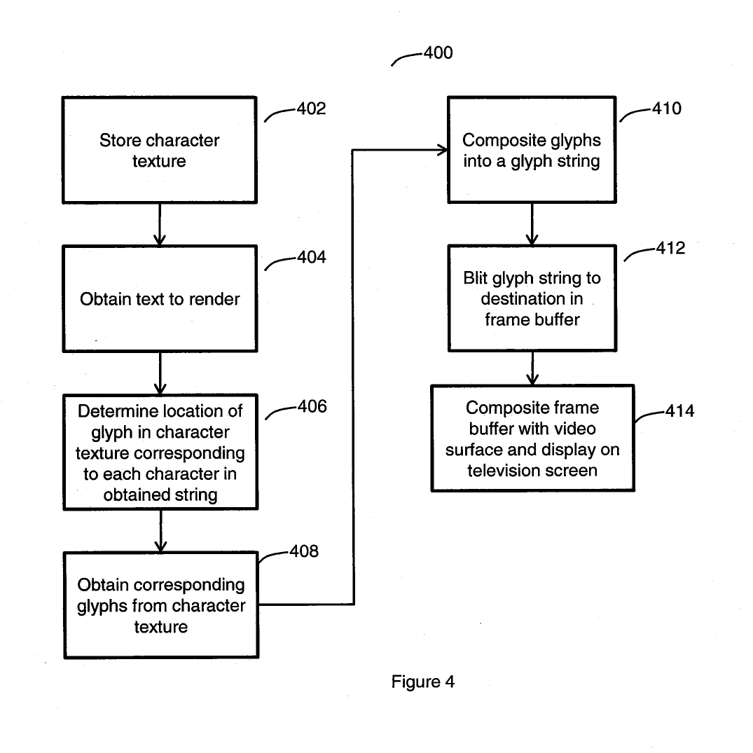

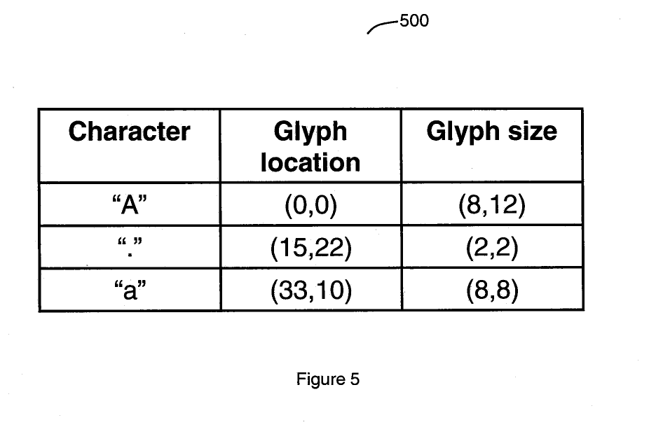

FIG. 4 is a flow chart 400 for a method for rendering text to a television screen according to an embodiment. In step 402, a character texture such as described above, is stored. Text to be rendered to the television screen is obtained in step 404. The text can be a single character or a string. In step 406, the location in the character texture of each glyph and its size corresponding to each character in the obtained text is determined. In an embodiment, step 406 is performed using a lookup table having characters in a character set with corresponding glyph locations and sizes for each glyph in the character texture. An exemplary such lookup table is described with respect to FIG. 5.

In step 408, glyphs corresponding to each character in the text are obtained from the character texture. The obtained glyphs are composited into a glyph string in step 410. In an embodiment, a glyph string is a portion of memory that holds all of the glyphs in the proper order for the string. Step 410 can be skipped if the text obtained in step 404 is a single character.

In step 412, the glyph string (or glyph in the case where the text to be rendered is a single character) is Witted to the appropriate destination rectangle in the frame buffer. And, in step 414, the frame buffer contents are composited with the video source contents and displayed on the television screen.

FIG. 5 illustrates a portion of an exemplary lookup table 500 for determining the location of glyphs in a character texture according to an embodiment. As shown in FIG. 5, each character has a corresponding glyph location in the character texture and glyph size. In an embodiment, the glyph location corresponds to the coordinate of the top left corner of the rectangle of the glyph's location in the character texture. In an embodiment, the glyph size corresponds to the dimension of the rectangle containing the glyph in the character texture. For example, in table 500, the top left corner of the rectangle containing character “A” is located at position (0,0) in the character texture, and the rectangle's size is 8×12. In that case, the coordinates of the remaining corners of the rectangle containing character “A” are determined as follows: top right corner (8,0), bottom left corner (0,12), and bottom right corner (8,12). Similarly for character “a”, the top left corner of the rectangle in the character texture is located at coordinate (33,10) and has a size of 8×8. Thus, the remaining coordinates of the rectangle containing character “a” are determined as follows: top right corner (41,10), bottom left corner (33,18), and bottom right corner (41,18).

In an alternate embodiment, the rectangle containing a glyph in the character texture can be defined by the coordinate of its top left corner and the coordinate of its bottom right corner. In such an embodiment, the remaining coordinates of the rectangle are readily determined. For example, if the coordinate of the top left corner of the rectangle containing the glyph in the character texture is (a,b) and the coordinate of the bottom right corner of the rectangle is (x,y), the coordinate of the top right corner of the rectangle is determined as (x,b), and the coordinate of the bottom left corner of the rectangle is determined as (a,y).

In operation, a table look up is performed to determine a match to a character in text to be rendered. The location information for the glyph corresponding to the character to be rendered is obtained and used to obtain the glyph corresponding to the character from the character texture. For a string, the obtained glyphs are composited into a glyph string for rendering as described above.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system to render anti-aliased text on a video screen, comprising:
a memory;
a frame buffer to store data to be displayed on the television screen;
a processor to obtain to the text to be rendered to the television screen; and
a blitter to blit glyphs corresponding to the text to be rendered to a destination rectangle in the frame buffer, wherein the glyphs are Witted using only the alpha channel.

2. The system of claim 1, further comprising:
a video surface to store video; and
a compositor to composite contents of the frame buffer with the video stored in the video surface for display on the television screen.

3. The system of claim 1, wherein the processor determines a location of a glyph corresponding to each character in the text to be rendered.

4. The system of claim 3, wherein the processor uses a lookup table to determine the location of each glyph.

5. The system of claim 1, further comprising a character texture comprising a plurality of glyphs, wherein each glyph is contained in a rectangle having a location in the character texture.

6. The system of claim 5, wherein each rectangle has a size dependent on the glyph it contains.

7. The system of claim 5, further comprising a lookup table to store each character in a character set corresponding to the character texture, and for each stored character, to store associated location information corresponding to a location in the character texture of a rectangle containing a glyph corresponding to the stored character.

8. The system of claim 7, wherein the location information includes a coordinate of a top left corner of the rectangle containing the glyph and a size of the rectangle containing the glyph.

9. The system of claim 7, wherein the location information includes a coordinate of a top left corner and a bottom right corner of the rectangle containing the glyph.

10. The system of claim 1, wherein a global color is applied to the alpha channel when glyphs are blitted to the frame buffer.

11. A method for rendering anti-aliased text on a video screen, comprising:
storing data to be displayed on a television screen in a frame buffer;
obtaining the text to be rendered to the television screen; and
blitting glyphs corresponding to the text to be rendered to a destination rectangle in the frame buffer, wherein the glyphs are Witted using only the alpha channel.

12. The method of claim 11, further comprising:
storing video in a video surface; and
compositing contents of the frame buffer with the video stored in the video surface for display on the television screen.

13. The method of claim 11, further comprising determining a location of a glyph corresponding to each character in the text.

14. The method of claim 13, further comprising using a lookup table to determine the location of each glyph.

15. The method of claim 1, further comprising storing each glyph in a character texture, wherein each glyph is contained in a rectangle having a location in the character texture.

16. The method of claim 15, wherein each rectangle has a size dependent on the glyph it contains.

17. The method of claim 15, further comprising storing each character in a character set corresponding to the character texture in a lookup table, and for each stored character, storing associated location information corresponding to a location in the character texture of a rectangle containing a glyph corresponding to the stored character.

18. The method of claim 17, wherein the location information includes a coordinate of a top left corner of the rectangle containing the glyph and a size of the rectangle containing the glyph.

19. The method of claim 17, wherein the location information includes a coordinate of a top left corner and a bottom right corner of the rectangle containing the glyph.

20. The method of claim 11, further comprising applying a global color to the alpha channel when glyphs are blitted to the frame buffer.
